(19) United States
(12) Patent Application Publication
(10) Pub. No.: US 2020/0187743 A1
(43) Pub. Date: Jun. 18, 2020

(54) COMPOSITE ARTICLE FOR MAINTAINING AND CLEANING HARD SURFACES

(71) Applicants: James L McArdle, Wilson, WI (US); Clint A Howle, Springdale, AR (US); Carl G Cabot, Bentonville, AR (US)

(72) Inventors: James L McArdle, Wilson, WI (US); Clint A Howle, Springdale, AR (US); Carl G Cabot, Bentonville, AR (US)

(21) Appl. No.: 16/796,854

(22) Filed: Feb. 20, 2020

Related U.S. Application Data
(63) Continuation-in-part of application No. 15/371,149, filed on Dec. 6, 2016.
(60) Provisional application No. 62/237,685, filed on Oct. 6, 2015.

(51) Int. Cl. A47L 11/40; B32B 7/12; A47L 11/14; A47L 11/282; B32B 5/02; B32B 5/26; B32B 5/16; D04H 3/011

(52) U.S. Cl. CPC A47L 11/4038; B32B 7/12; A47L 11/14; A47L 11/282; B32B 5/022; B32B 5/26; B32B 2432/00; D04H 3/011; B32B 2262/0261; B32B 2262/0284; B32B 2264/00; B32B 2250/02; B32B 5/16

(57) ABSTRACT

The invention provides an article of manufacture useful for simultaneously maintaining, cleaning and polishing hard surfaces comprising independently a driver element composite pad comprised of a top non-woven layer and one or more non woven bottom layers laminated together with an adhesive interlayer, said composite pad having a central opening extending through all the layers and one or more equidistant or non-equidistant openings on the top nonwoven layer therein and polishing inserts elements disposed in said equidistant or non-equidistant openings. The invention also provides a kit for polishing hard surfaces comprising: (a) a driver element having a central opening and one or more equidistant or non-equidistant openings; (b) polishing inserts elements for said driver element having equidistant or non-equidistant openings; and wherein said kit provides a hard surface with a consistent and improved surface smoothness and reflected image quality.

This application is a continuation-in-part of U.S. Ser. No. 15/371,149 entitled “Composite Article For Maintaining And Cleaning Hard Surfaces” filed Dec. 6, 2016; which is in its entirety herein incorporated by reference. This application also claims the priority benefit under 35 U.S.C. section 119 of U.S. Provisional Patent Application No. 62/237,685 entitled “Composite Abrasive Article For Cleaning” filed on Oct. 6, 2015; and which is in its entirety herein incorporated by reference.

### FIELD OF THE INVENTION

The present invention relates generally to pads and polishing discs for use with floor cleaning machines for cleaning and polishing stone, terrazzo, and/or concrete floors.

The present disclosure relates to a method and a tool for maintenance of hard surfaces, primarily concrete (cement), cementatious and epoxy terrazzo floors, and natural stone (e.g. granite, limeatone, marble) floor surfaces. The disclosure particularly relates to a method and a tool for maintenance which are suitable for use on a regular basis to maintain a polished hard floor surface, or for any polished hard surface such as a counter or tabletop.

The instant invention also relates to methods for maintenance of hard, smooth surfaces, primarily wood, linoleum, lacquer and vinyl floor surfaces. The disclosure particularly relates to a methods for maintenance which are suitable for use on a daily basis to maintain an aesthetically pleasing, shiny, hard, smooth surface.

The instant invention further relates to an article of manufacture useful for maintaining and polishing hard surfaces. The present invention also relates to an article of manufacture that provides consistent and improved surface smoothness and reflected image quality. The present invention further relates to a composite abrasive article for cleaning and maintaining aesthetic properties of hard surfaces, such as concrete, terrazzo, and natural stone (e.g., granite, marble).

This invention also relates to an abrasive material and an abrasive inserts provided with at least one abrasive material, which are used in a process for polishing or chemicomechanically polishing substrate materials, for example, for substrates such as stone, terrazzo, and concrete floors.

The instant invention is also directed to a composite layered pad comprised of two or more non woven layers laminated together with an adhesive interlayer.

### BACKGROUND OF THE INVENTION

Scouring, cleaning and polishing pads are widely known and used to clean and restore stone, terrazzo, and/or concrete floors and surfaces. Often, such pads are disc-shaped and fitted to a conventional floor-cleaning machine of a conventional type, such as, for example, an auto scrubber or a swing-type floor machine. Typically, floor-cleaning machines apply pressure to the disc-shaped pads and rotate or gyrate the pads against the floor to be cleaned/polished. It is widely known in the art for a user to apply a cleaning solution to the floor before applying the disc-shaped pads thereto, to aid the pads in successfully removing dirt and/or residue from the floor.

Numerous techniques are known for grinding, polishing, and finishing hard surfaces like concrete, terrazzo, and stone floors. These techniques employ various abrasive materials and chemicals that work on the surface to grind and polish the surface to a desired finish. For hard surfaces, like concrete flooring, the abrasive materials often employ diamonds or diamond particles that are embedded in a metallic, resinous, or similar binder. The diamond abrasives can be mixed with resins and impregnated into lofty, nonwoven carrier webs, or they may be mixed with resins and coated onto a variety of carrier pads or can be molded into abrasive components that are then attached to a carrier pad or carrier plate. For example, U.S. Pat. No. 794,495 to Gorton and U.S. Pat. No. 2,001,911 to Wooddell et al. describe cloth, fiber, thin sheet metal, or paper carrier disks with a plurality of abrading elements attached to the surfaces thereof. U.S. Pat. No. 6,234,886 to Rivard et al. describes a non-woven carrier pad with an abrasive coating applied to a working surface thereof and a plurality of abrasive sheets, e.g. sandpaper, coupled to the working surface. U.S. Pat. No. 7,204,745 to Thysell describes a non-woven pad with shallow recesses in which spring-mounted rigid, diamond-containing resinous elements mounted in thermoplastic holders are disposed.

These carrier pads and/or molded abrasive components are coupled to a rotary grinding or polishing machine. Common grinding and polishing machines include an electric or propane motor rotatably coupled to a single platen or to a plurality of platens in a planetary arrangement. The carrier pad and/or the molded abrasive components are coupled to the platen and are rotated while in contact with a floor surface to abrade the surface.

Preparation of surfaces from a rough, coarse-cut material to a polished, aesthetically-pleasing, reflective finished surface employs a sequence of steps, each step of which employs a carrier pad and/or abrasive element having a different grit or coarseness. The preparation begins with more coarse abrasive materials and progresses through a number of sequentially finer grit materials until a desired finish is achieved. For example, one common progression for preparing concrete begins with a 30-40 grit metal-bonded diamond particle abrasive elements and then proceeds through similar 80 and 150 grit abrasive elements. The concrete surface is then typically polished using 100 grit abrasive elements of resin-bonded diamond particles followed by similar abrasive elements of 200 grit and successively higher grits to a desired finish where each grit is typically double the previous grit. The polished surface is then treated with a penetrating or topical sealer to prevent staining of the surface and to facilitate release of soiling agents. The final, aesthetically-pleasing surface quality is then ideally preserved through subsequent cleaning and maintenance conducted on a regular (e.g. daily) schedule.

Typically, lofty, nonwoven disc pads are used to clean and polish stone and concrete floors following a regular cleaning and maintenance schedule, for example, on a daily basis or even more frequently in many retail and business environments. Abrasive particles incorporated into the web structure of the nonwoven disc pads impart abrasive action during ongoing cleaning and maintenance in order to enhance the cleaning and help maintain aesthetic appearances. Most recently, many disc pad manufacturers have included diamond abrasive particles in the lofty, nonwoven cleaning pad structure. However, it is known that long-term, regular use of so-called diamond-impregnated pads results in increased of surface roughness and consequent degradation of the aesthetic reflective qualities of the polished surface as the individual diamond particles attached to resiliant web fibers are free to move up and down and preferentially erode away softer portions of the polished stone or concrete surface.

Thus it can be seen that needs exist for improvements to pads for simultaneously cleaning and polishing the surface of stone, terrazzo, concrete, and the like, the pad having abrasive particles incorporated into the pad in such a way that long-term use as a cleaning or maintenance tool enhances, rather than degrades the smoothness and aesthetic qualities of the polished surface. Additionally, it can be seen that needs exist for improvements in the materials used in the construction of cleaning/polishing pads that offer longer life spans and improved polishing qualities. It is to the provision of a cleaning and polishing article that meets these needs and others that the present invention is primarily directed. This invention provides a durable, nonwoven abrasive article having a significantly longer useful product life compared to conventional abrasive products, and especially compared to diamond-impregnated pads. This invention also provides for cleaning and consistently improved surface smoothness and enhanced aesthetic quality of the polished surface when used repeatedly over time.

The present disclosure provides an abrasive article and a system. Related references include: US 2011/0207383 Thysell, “Methods and tool for maintenance of hard surfaces, and a method for manufacturing such a tool”, U.S. Pat. No. 8,323,072 McArdle, et al, “Method of polishing transparent armor” and US 2013/0065490 McArdle, et al, “Method of refurbishing vinyl composition tile”.

### BRIEF DESCRIPTION OF THE FIGURES

FIG. 1 shows a composite abrasive article of the invention mounted on a swing-type rotary floor machine.

FIG. 1A also shows a composite pad (two layer construction as shown in FIG. 2E) abrasive article of the invention mounted on a swing-type rotary floor machine.

FIG. 2 is a bottom perspective of pad with one insert exploded away and illustrates the composite abrasive article with the insert elements of the invention.

FIG. 2A illustrates a composite two layer pad having a central opening through all the layers and four equidistant openings on the top layer.

FIG. 2B is a top perspective of a composite two layer pad with one insert exploded away and illustrates the composite abrasive article with the insert elements of the invention.

FIG. 2C illustrates a composite two layer pad having a central opening through all the layers and three equidistant openings on the top layer.

FIG. 2D features a composite two layer pad having a central opening through all the layers and three equidistant openings on the top layer with abrasive elements.

FIG. 2E shows a composite two layer pad having a central opening through all the layers and abrasive elements placed on the three equidistant openings on the top layer.

FIG. 3 features a full section of the composite abrasive article through two inserts on a surface being polished.

FIG. 4 is a top perspective of the composite abrasive article of the invention.

FIG. 5 shows a section through one of the inserts of the invention.

FIG. 6 illustrates a whole insert having a diamond polishing surface.

FIG. 7 features an insert element in a square geometry.

FIG. 8 shows an insert element in an oval/elliptical geometry.

FIG. 9 is a graph of distinctness of image, DOI, using an Example VIII article.

FIG. 10 is a graph of reflective image quality, Haze, using an Example VIII article.

FIG. 11 shows a graph of surface roughness, Rk, using an Example VIII article.

FIG. 12 illustrates a graph of distinctness of image, DOI using a comparative Example A nonwoven abrasive article.

FIG. 13 is a graph of reflected image quality, Haze, using a Comparative Example A nonwoven abrasive article.

FIG. 14 illustrates a graph of surface roughness, Rk, using a Comparative Example A nonwoven abrasive article.

FIG. 15 shows a graph of distinctness of image, DOI, using a Comparative Example B nonwoven abrasive article.

FIG. 16 is a graph of reflected image quality, Haze, using a Comparative Example B nonwoven abrasive article.

FIG. 17 shows a graph of surface roughness, Rk, using a Comparative Example A nonwoven abrasive article.

### SUMMARY OF THE INVENTION

The invention provides an article of manufacture useful for simultaneously cleaning and polishing hard surfaces comprising independently a driver element (non-woven web) having a central opening and one or more equidistant or non-equidistant openings through the entire thickness of the driver element therein, and distinct polishing inserts elements disposed in said equidistant or non-equidistant openings, wherein said article upon cleaning and polishing a surface provides a consistent and improved surface smoothness and reflected image quality.

The invention also features an article of manufacture useful for simultaneously maintaining, cleaning and polishing hard surfaces comprising independently a driver element composite pad comprised of a top non-woven layer and one or more non woven bottom layers laminated together with an adhesive interlayer, said composite pad having a central opening extending through all the layers and one or more equidistant or non-equidistant openings on the top nonwoven layer therein and polishing inserts elements disposed in said equidistant or non-equidistant openings, wherein said article upon repeatedly cleaning and polishing a previously-prepared surface provides a decreased surface roughness value, an increased distinctness of image value, and a decreased haze value.

The invention is also directed to a polishing element comprising a non-woven web having a top surface and a bottom surface; said polishing element having incorporated in a layer within a depth from one of its surfaces abrasive particles and wherein said polishing element provides a consistent and improved surface smoothness and reflected image quality.

The invention further provides a kit for cleaning and polishing hard surfaces comprising: (a) a driver element having a central opening and one or more equidistant or non-equidistant openings; (b) polishing inserts elements for said driver element having equidistant or non-equidistant openings; and wherein said kit provides said hard surfaces with a consistent and improved surface smoothness and reflected image quality.

The present disclosure provides a system that includes a lofty non-woven driver article and three dimensional, structured abrasive particles present within or throughout the insert article. The structured abrasive particles are agglomerate particles composed of a binder with abrasive particles (e.g., diamond) distributed throughout the binder. The binder may be a polymeric binder, metal binder, or ceramic binder. The lofty insert article holding and supporting the structured abrasive particles may or may not have abrasive particles present on the fibers forming the lofty article.

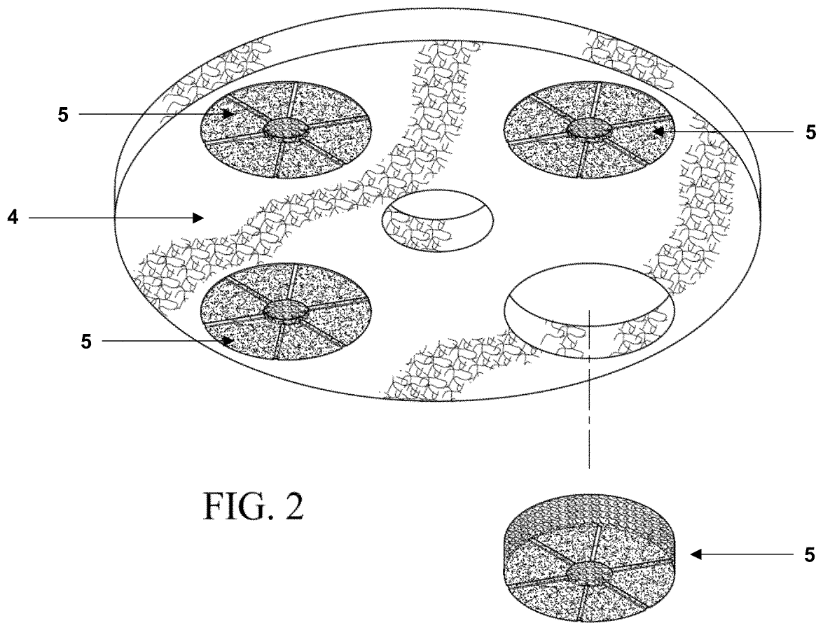

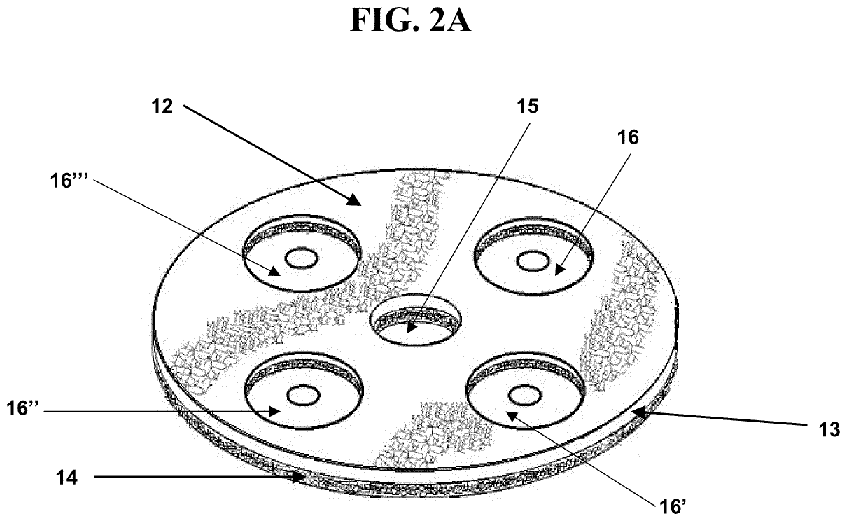

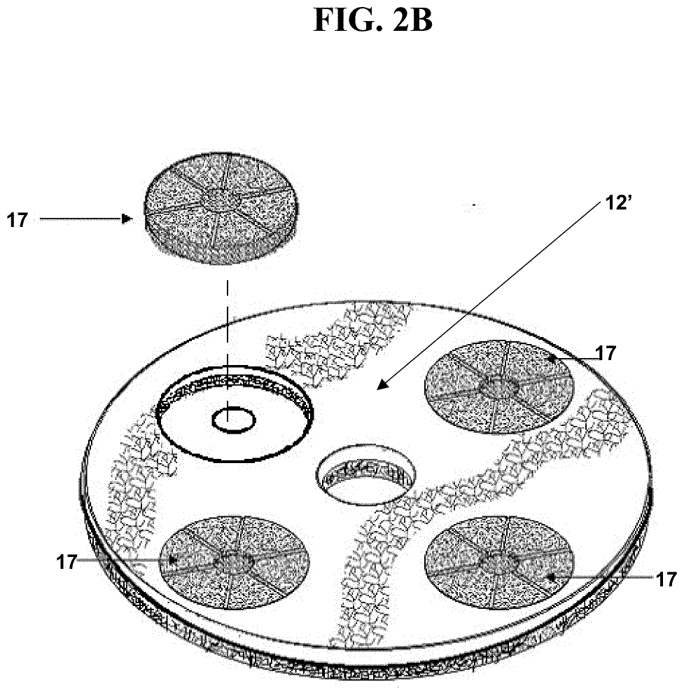

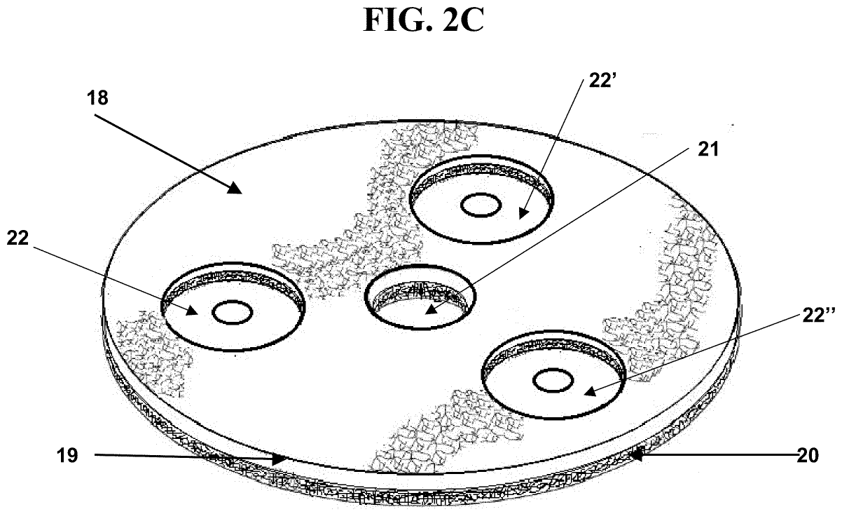

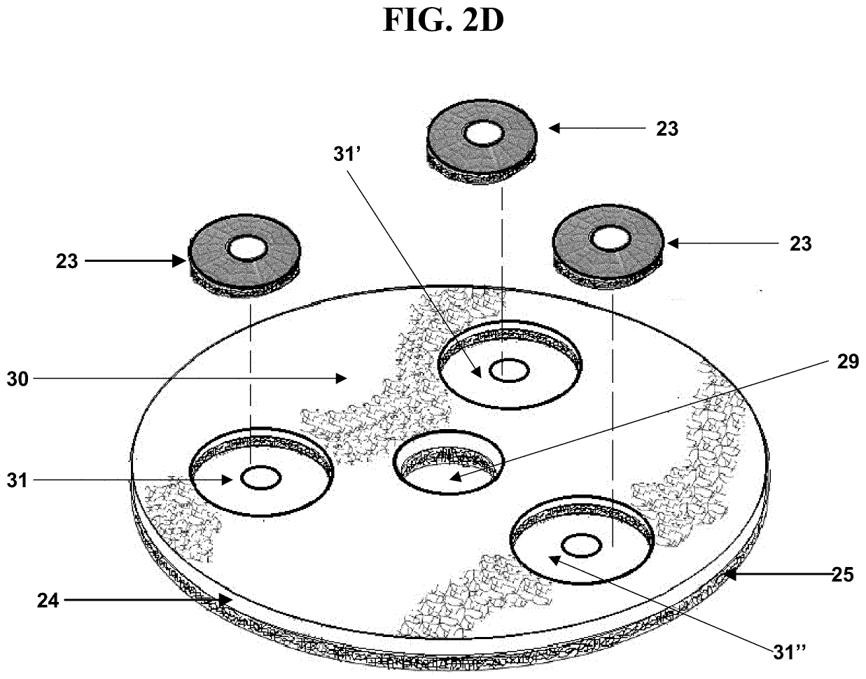

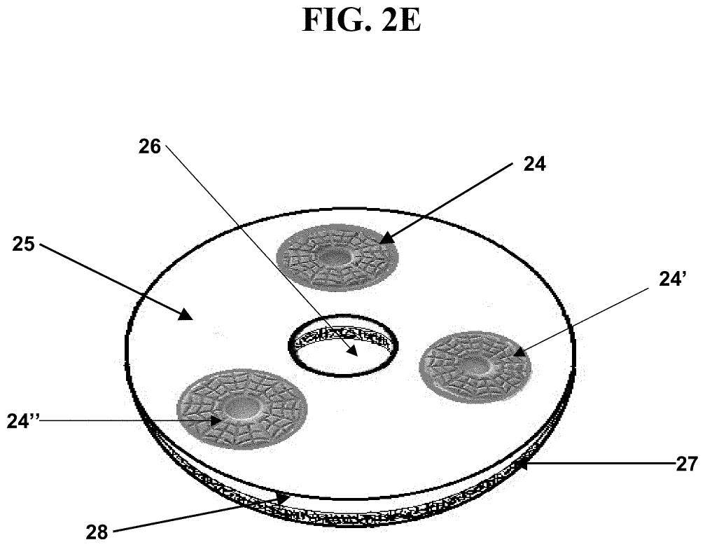

The invention further provides principal nonwoven driver elements which may or may not contain abrasive particles within, and, secondary insert elements which contains structured abrasive agglomerate particles. Principal and secondary elements are combined in a composite abrasive article (See FIG. 2), suitable for use with, for example, a swingtype or auto scrubber-type rotary floor machine.

The particular embodiment illustrated in FIG. 2 has several abrasive insert articles 5 equally distributed within the lofty driver article 4. In other embodiments, more or fewer abrasive insert articles are present within the lofty driver article. If more than one abrasive insert article is present, the multiple insert abrasive articles may all be the same or may be different, e.g., by shape, size composite shape and/or size, abrasive particle type/shape/size, etc.

The surface of the structured abrasive insert articles may be level with the surface of the lofty driver article, or may be recessed slightly below or a slightly above the surface of the lofty driver article.

The principal non-woven driver article is selected to perform routine cleaning, to fix the secondary abrasive insert articles in place, and to provide a means for attaching the composite abrasive article onto the drive pad of a rotary machine.

Multiple, secondary abrasive insert articles are selected to provide suitable supporting surfaces for abrasive elements. The secondary non woven abrasive insert articles are further selected to cause a suitable level of mechanical pressure on the abrasive elements in contact with the hard surface. The abrasive insert elements are selected to impart hard-surface burnishing action, thereby decreasing surface roughness and maintaining, or preferably improving desirable aesthetic properties, including, but not limited to, gloss, haze, and distinctness of image (DOI).

Principal and secondary articles are selected to have potentially different levels of mechanical stiffness, or compression resistance, or compressability, depending on the type of surface being cleaned and maintained. For example, a hard polished concrete surface may require a soft, compressable driver article for gentle cleaning, coupled with a stiff, low-compressability insert article for polishing the hard surface. Whereas, a soft marble surface may require a soft, compressable driver coupled with a relatively softer, more compressible polishing insert article to lessen the chance of gouging or scratching the soft marble surface. Some surfaces may require that driver and insert articles have the same stiffness or compression resistance. In all cases, the driver and insert articles are distinct, separate articles.

The present invention also provides a composite novel pad comprised of two or more non woven layers laminated together with an adhesive interlayer. With typical single-layer non woven pads, holes are die-cut through the thickness of the pad to provide apertures for inserting secondary grinding and polishing elements. The composite nature of the laminated pad allows inclusion of certain features in the pad assembly, such as for example, blind-hole insert pockets. Such precisely-dimensioned features are not possible with a single-layer non woven pad construction.

### DETAILED DESCRIPTION OF THE INVENTION

The present invention provides an article of manufacture useful for simultaneously maintaining, cleaning and polishing hard surfaces comprising independently a driver element (non-woven web) having a central opening and one or more equidistant or non-equidistant openings therein and polishing inserts elements disposed in said equidistant or non-equidistant openings, wherein said article upon cleaning and polishing a surface provides a consistent and improved surface smoothness and reflected image quality.

The manufacture of the article of the invention starts with initially making molds. Typically, a translucent cylindrical silicone rubber mold or other suitable material havig a size in the range of between 1″ dia×¼″ high to about 4″ dia×⅝″ high is cast in a ring of Schedule 40 PVC plumbing pipe using Sylgard™ 184 elastomer (Dow Corning). A plastic core was used to form a flat-bottomed cylindrical cavity that has dimensions in the range from about 1½″ in diameter and 1/10″ deep to about 3½″ in diameter and ¼″ deep. The core includes six grooves which are triangular in cross-section having dimensions of about 1/32″ wide to 1/32″ deep to about 1/16″ wide× 1/16″ deep and arranged radially on the core face at 2:00, 4:00, 6:00, 8:00, 10:00 and 12:00 positions. The mold casting is typically allowed to cure for 4 hours at room temperature.

After making the molds toroid-shaped insert substrates are cut from nonwoven pad material using a cylindrical rule die and a 20-ton hydraulic die press. The insert substrates were 3½″ outside dia., 1″ inside dia, however other dimensions could be chosen depending on the final use of the substrates.

The nonwoven pad material useful for making the insert susbtrates is derived from synthetic fibers such as those made from polyester (e.g., polyethylene terephthalate), nylon (e.g., hexamethylene adipamide, polycaprolactam), polypropylene, acrylonitrile (i.e., acrylic), rayon, cellulose acetate, polyvinylidene chloride-vinyl chloride copolymers, and vinyl chloride-acrylonitrile copolymers. Examples of suitable natural fibers include cotton, wool, jute, and hemp. The fiber may be of virgin material or of recycled or waste material, for example, reclaimed from garment cuttings, carpet manufacturing, fiber manufacturing, or textile processing. The fiber may be homogenous or a composite such as a bicomponent fiber (e.g., a co-spun sheath-core fiber). The fibers may be tensilized and crimped, but may also be continuous filaments such as those formed by an extrusion process. Combinations of fibers may also be used. The nonwoven materials are manufactured according to commonly owned U.S. provisional application No. 62/427,840 filed Nov. 30, 2016 the entire contents of which are incorporated by reference herein.

The nonwoven driver articles are made as follows: four cylindrical cavities of 1½″ to 5½″ dia. are cut completely through the thickness of a 20″ diameter nonwoven pad, using a 1½″ to 5½″ cylindrical rule die and a 20-ton hydraulic die press. The through-cavities are spaced at 3:00, 6:00, 9:00 and 12:00 positions near the periphery of the 20″ diameter nonwoven pad. The cavities were spaced approximately 8″ radially from the center of the nonwoven pad to the center of the cavities. The material cut from inside the cylindrical cavities was removed. The geometry of the cavities can be circular, square, rectangular, oval or any other desired geometry.

In another embodiment of the invention, there is provided a composite novel pad comprised of two or more non woven layers laminated together with an adhesive interlayer. With typical single-layer non woven pads, holes are die-cut through the thickness of the pad to provide apertures for inserting secondary grinding and polishing elements. The composite nature of the laminated pad allows inclusion of certain features in the pad assembly, such as for example, blind-hole insert pockets. Such precisely-dimensioned features are not possible with a single-layer non woven pad construction. The composite pad construction further permits selection of component non woven materials for each layer having different, desirable properties. When combined in the assembled construction, each distinct layer contributes uniquely to enhance the performance of the pad assembly.

The component non woven layers may include fibers selected from, for example, polyester, nylon, polypropylene, rayon, acrylic, glass, and natural fibers. Nonwoven mat bonding materials may include, for example, latex, acrylic, and phenolic resins.

The nonwoven polishing insert articles are manufactured as follows: A mix of materials which include a curable resin (thermally curable or radiation curable), a silane coupling agent, a photoinitiator, a filler, thermal initiator, mineral fiber, inorganic powders and agglomerated abrasive particles are mixed together to form an abrasive slurry. The slurry components are mixed together, using an electric mixer and a four-blade impeller at 300 rpm for ˜15 minutes. or longer as required. A silicone mold produced as described above, is sprayed with a mold release agent and allowed to air-dry for ˜5 minutes at room temperature.

The abrasive slurry mix is then poured into the mold cavity. The mold is agitated by hand to release air bubbles from the mold surfaces and from within the slurry liquid. A nonwoven insert substrate produced as described above is placed in the mold cavity and downward pressure applied by hand to force the slurry into the lofty nonwoven face of the insert substrate.

A UVA light source is then placed on a horizontal surface with the UV bulb and reflector facing upward. The UV lamp is turned on and allowed to warm up for 15-30 minutes with the power switch set to “standby”.

The silicone mold containing the insert substrate and abrasive slurry is then placed directly onto the UV lamp shielding glass above the UV lamp bulb. The UV power source is switched on to “high.” After ˜15 seconds, the abrasive slurry which resides impregnated into the insert substrate is at least partially cured to a rigid state, and the mold is removed from over the UV lamp.

The at least partially cured abrasive insert is then removed from the silicone mold by peeling the elastomeric mold body from the insert. The de-molded, at least partially cured insert is then placed back on the UV light source for ˜40 seconds to ensure complete curing of the abrasive insert.

Typical curable resins that can be used to make the polishing inserts include ethylene glycol di(meth)acrylate, hexanediol di(meth)acrylate, triethylene glycol di(meth)acrylate, trimethylolpropane tri(meth)acrylate, glycerol tri(meth)acrylate, pentaerythritol tri(meth)acrylate, ethoxylated trimethylolpropane tri(meth)acrylate, neopentyl glycol di(meth)acrylate, pentaerythritol tetra(meth)acrylate, dipentaerythritol penta(meth)acrylate, sorbitol tri(meth)acrylate, sorbitol hexa(meth)acrylate, Bisphenol A di(meth)acrylate, ethoxylated Bisphenol A di(meth)acrylates, acrylated epoxy oligomers (e.g., Bisphenol-A based epoxy acrylate oligomers such as, for example, those marketed under the trade designations “EBECRYL 3500”, “EBECRYL 3600”, “EBECRYL 3720”, and “EBECRYL 3700” by UCB Radcure), and acrylated polyesters (e.g., as marketed by UCB Radcure under the trade designation “EBECRYL 870”), and mixtures thereof.

The curable compositions according to the present invention may also include from 0.1 to 15 percent by weight or more of at least one novolac phenolic resin, based on the total weight of all the components.

Typically, novolac resins are made by reacting a phenolic monomer (e.g., phenol, cresol, xylenol, resorcinol, catechol, bisphenol A, naphthol, or a combination thereof) with an aldehyde in the presence of an acid catalyst, with the molar ratio of the aldehyde to phenol being less than one. Examples of aldehydes used to prepare novolacs include formaldehyde, acetaldehyde, propionaldehyde, glyoxal, and furfural. Typically, these novolac resins have a molecular weight ranging from 300 to 1,500, although higher and lower molecular weights may also be useful. Additionally, the starting phenolic monomer can be substituted with various groups such as alkyl, alkoxy, carboxyl, and sulfo, as long as there are at least two reactive sites remaining to form the novolac.

Many novolac phenolic resins are readily available from commercial suppliers including, for example, Georgia Pacific Resins, Atlanta, Ga. (e.g., as marketed under the trade designations “GP 2074”, “GP 5300”, “GP 5833”, “RESI-FLAKE GP-2049”, “RESI-FLAKE GP-2050”, or “RESI-FLAKE GP-221 1”); Bakelite AG, Frielendorf, Germany (e.g., as marketed under the trade designation “RUTAPHEN 8656F”); Borden Chemical, Inc (e.g., as marketed under the trade designations “DURITE 423A” or “DURITE SD1731”).

The silane coupling agent is selected from the group consisting of 3-mercapto-propylmethyldimethoxisilane, (3-glycidoxypropyl)methyldiethoxysilane, (3-glycidoxypropyl)tri-methoxysilane, (3-trimethoxysilylpropyl)diethylenetriamine, (N,N-diethyl-3-aminopropyl)tri-ethoxysilane, 3-aminopropylmethyldiethoxysilane, 3-aminopropyltriethoxysilane, 3-amino-propyltrimethoxysilane, 3-chloropropylmethyldichlorosilane, 3-chloropropylmethyldimethoxysilane, 3-chloropropyltrichlorosilane, 3-chloropropyltriethoxysilane, 3-chloropropyltrimethoxy-silane, 3-mercaptopropyltriethoxysilane, 3-mercaptopropyltrimethoxysilane, bis[3-(triethoxy-silyl)propyl]-tetrasulfide, chloromethyltrichlorosilane, chloromethyltriethoxysilane, chloro-methyltrimethoxysilane, methacryloxypropyltrimethoxysilane, methyltriacetoxysilane, methyl-tris(methylethylketoxime) silane, N-(2-aminoethyl)-3-aminopropyl methyldi methoxysilane, N-(2-aminoethyl)-3-aminopropyltrimethoxysilane, N-methyl aminopropyltrimethoxysilane, phenyltris(methylethylketoximino)silane, tetrakis(methylethylketoximino) silane, trifluoropropyl-methyldimethoxysilane, trifluoropropyltrimethoxysilane, ureidopropyltrimethoxysilane, vinyldi-methylethoxysilane, vinylmethylbis(methylethylketoximino) silane, vinyltrichlorosilane, vinyltri-ethoxysilane, vinyltrimethoxysilane, vinyltris(2-methoxyethoxy)silane, vinyltris(methyl ethyl-ketoximino)silane and gamma-methacryloxypropyltrimethoxysilane.

The photoinitiator may be a single photoinitiator or a combination of two or more photoinitiators. Photoinitiators useful in the practice of invention include those known as useful for photocuring free-radically the resins of the invention. Exemplary photoinitiators include benzoin and its derivatives such as α-methylbenzoin; α-phenylbenzoin; α-allylbenzoin; α-benzylbenzoin; benzoin ethers such as benzil dimethyl ketal (available, for example, under the trade designation “IRGACURE 651” from Ciba Specialty Chemicals, Tarrytown, N.Y.), benzoin methyl ether, benzoin ethyl ether, benzoin n-butyl ether; acetophenone and its derivatives such as 2-hydroxy-2-methyl-1-phenyl-1-propanone (available, for example, under the trade designation “DAROCUR 1173” from Ciba Specialty Chemicals) and 1-hydroxycyclohexyl phenyl ketone (available, for example, under the trade designation “IRGACURE 184” from Ciba Specialty Chemicals); 2-methyl-1-[4-(methylthio)phenyl]-2-(4-morpholinyl)-1-propanone (available, for example, under the trade designation “IRGACURE 907” from Ciba Specialty Chemicals); 2-benzyl-2-(dimethylamino)-1-[4-(4-morpholinyl)phenyl]-1-butanone (available, for example, under the trade designation “IRGACURE 369” from Ciba Specialty Chemicals).

Other useful photoinitiators include pivaloin ethyl ether, anisoin ethyl ether; anthraquinones, such as anthraquinone, 2-ethylanthraquinone, 1-chloroanthraquinone, 1,4-dimethylanthraquinone, 1-methoxyanthraquinone, benzanthraquinonehalomethyltriazines, and the like; benzophenone and its derivatives; iodonium salts and sulfonium salts as described hereinabove; titanium complexes such as bis(η₅-2,4-cyclopentadien-1-yl)bis[2,6-difluoro-3-(1H-pyrrol-1-y-1)phenyl]titanium (obtained under the trade designation “CGI 784 DC”, also from Ciba Specialty Chemicals); halomethylnitrobenzenes such as 4-bromomethylnitrobenzene and the like; mono- and bis-acylphosphines (available, for example, from Ciba Specialty Chemicals under the trade designations “IRGACURE 1700”, “IRGACURE 1800”, “IRGACURE 1850”, and “DAROCUR 4265”) and bis(2,4,6-trimethylbenzoyl)-phenylphosphineoxide.

The thermal initiator is selected from the group consisting of 4,4′-azobis(4-cyanovaleric acid), 4,4′-azobis(4-cyanovaleric acid), 1,1′-azobis(cyclohexanecarbonitrile), 2,2′-azobis(2-methylpropionamidine) dihydrochloride granular, 2,2′-azobis(2-methylpropionitrile), 2,2′-azobis(2-methylpropionitrile) recrystallized, azobisisobutyronitrile, 2,2′-azobis(2,4-dimethyl-valeronitrile), tert-butyl hydroperoxide, tert-butyl peracetate, cumene hydroperoxide, 2,5-di-(tert-butylperoxy)-2,5-dimethyl-3-hexyne, di cumyl peroxide, 2,5-bis(tert-butylperoxy)-2,5-di-methylhexane, 2,4-pentanedione peroxide, 1,1-bis(tert-butylperoxy)-3,3,5-trimethyl cyclohexane, 1,1-bis(tert-butylperoxy)cyclohexane, benzoyl peroxide, 2-butanone peroxide, tert-butyl per-oxide, lauroyl peroxide, tert-butyl peroxybenzoate, tert-butylperoxy 2-ethylhexyl carbonate, tert-butyl hydroperoxide and inorganic peroxides such as ammonium persulfate, hydroxymethane-sulfinic acid monosodium salt dihydrate, potassium persulfate and sodium persulfate.

Useful abrasive particles may comprise, for example, fused aluminum oxide (including white fused alumina, heat-treated aluminum oxide, and brown aluminum oxide), ceramic aluminum oxide, heated treated aluminum oxide, silicon carbide, diamond (natural and synthetic), cubic boron nitride, boron carbide, titanium carbide, garnet, fused alumina-zirconia, ceramic alumina-zirconia, diamond, zirconia, and combinations thereof. Of these, diamonds are preferred. Useful diamonds may be either natural diamonds or man-made diamonds. The diamonds may include a surface coating (e.g., nickel or other metal) to improve the retention of the diamonds in the resin matrix.

Abrasive particles may also be present in abrasive agglomerates. Such agglomerates comprise a plurality of the abrasive particles, a matrix material, and optional additives. The matrix material may be organic and/or inorganic. The matrix material can be, for example, polymer resin, glass (e.g., vitreous-bond diamond aggregates), metal, glass-ceramic, ceramic (e.g., ceramic-bond agglomerates), or a combination thereof. For example, glass, such as silica glass, glass-ceramics, borosilicate glass, phenolic, epoxy, acrylic, and the other resins can be used as the agglomerate matrix material. Abrasive agglomerates may be randomly shaped or have a selected shape associated with them.

Fired agglomerated particles are manufactured according to our U.S. provisional application Ser. No. 62/427,811 filed Nov. 30, 2016 the entire contents of which are incorporated by reference herein.

Fillers than can be used with the invention include wood pulp, vermiculite, and combinations thereof, metal carbonates, such as calcium carbonate, e.g., chalk, calcite, marl, travertine, marble, and limestone, calcium magnesium carbonate, sodium carbonate, magnesium carbonate; silica, such as amorphous silica, crystalline silica, quartz, glass beads, glass powder, glass bubbles, and glass fibers; silicates, such as talc, clays (montmorillonite), feldspar, mica, calcium silicate, calcium metasilicate, sodium aluminosilicate, aluminum silicate, sodium silicate; metal sulfates, such as calcium sulfate, barium sulfate, sodium sulfate, aluminum sodium sulfate, aluminum sulfate; gypsum; vermiculite; peerless clay, wood flour; aluminum trihydrate; platey white alumina, metal oxides, such as calcium oxide (lime), aluminum oxide, titanium dioxide, and metal sulfites, such as calcium sulfite, marble, limestone, flint and the like.

Mineral fibers include glasswool, rockwool, slagwool, glass filaments, and ceramic fibers, rock wool, micro glass fiber, refractory ceramic fiber, refractory mullite fiber, potassium titanium whisker, silicon carbide whisker, titanium oxide whisker, and wollastonite fibers.

In one embodiment of the invention the slurry composition include the following components: trimethylol propane triacrylate, gamma-methacryloxypropyltrimethoxysilane, bis(2,4,6-trimethylbenzoyl)-phenylphosphineoxide, amorphous silica filler, 2,2′-azobis(2,4-dimethylvaleronitrile), (mineral fiber) mineral fiber, calcium silicate, platey white alumina and fired agglomerated abrasive particles.

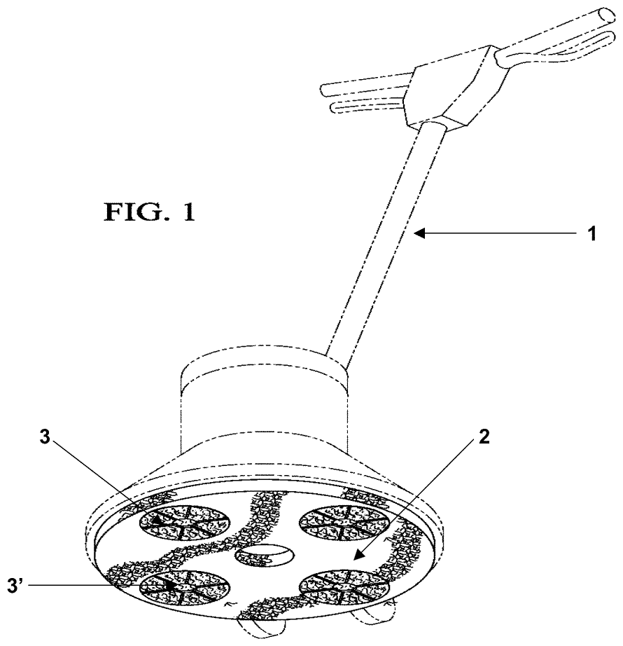

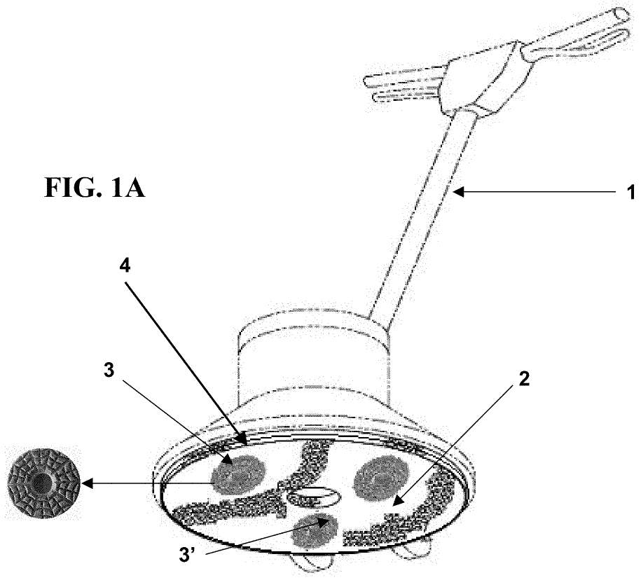

The composite article of the invention is depicted in FIG. 1 mounted on a swing-type floor scrubbing machine 1 where numeral 2 denotes the driver and numeral 3 and 3′ denotes the abrasive inserts. In FIG. 1A there is also shown a composite pad (two layer construction as shown in FIG. 2E) abrasive article of the invention mounted on a swing-type floor scrubbing machine 1 where numeral 2 denotes the driver and numeral 3 and 3′ denotes the abrasive inserts and reference numeral 4 denotes the two layer construction of the composite.

In FIG. 2, there is shown a bottom perspective of the pad 4 with one insert 5 exploded away and illustrates the composite abrasive article with the insert 5 elements of the invention.

FIG. 2A illustrates a composite two layer pad 12 having a central opening 15 through all the layers and four equidistant openings 16, 16′, 16″ and 16′″ on the top layer 13. The two layer pad of FIG. 2A includes top layer 13 and bottom layer 14.

In FIG. 2B, there is illustrated a top perspective of a composite two layer pad 12′ with one insert 17 exploded away and illustrates the two layer composite abrasive article with the insert elements 17 of the invention.

FIG. 2C illustrates a composite two layer pad 18 having layers 19 and 20 and having a central opening 21 through all the layers and three equidistant openings designated as 22, 22′ and 22″ on the top layer.

FIG. 2D features a composite two layer pad 30 having layers 24 and 25 and having a central opening 29 through all the layers and three equidistant openings on the top layer designated as 31, 31′ and 31″ on the top layer with abrasive elements 23.

FIG. 2E shows a composite two layer pad 25 having layers 27 and 28 and having a central opening 26 through all the layers and abrasive elements 24, 24′ and 24″ placed on the three equidistant openings on the top layer 28.

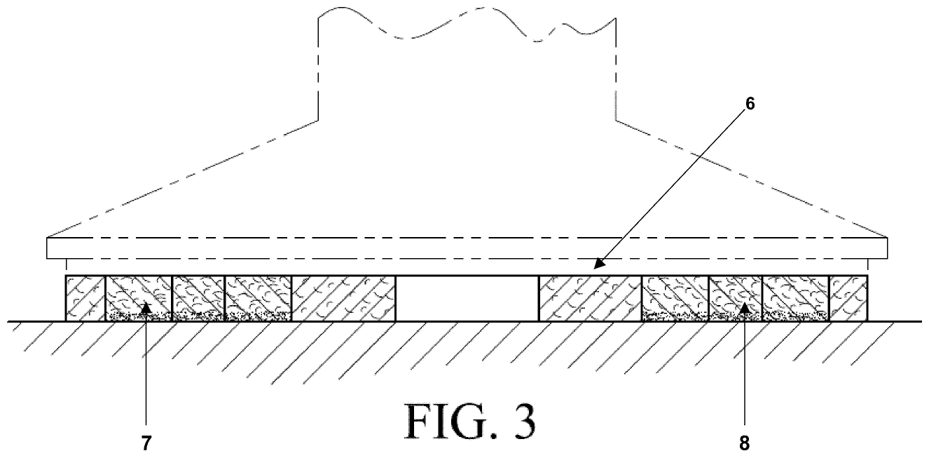

In FIG. 3 there is shown a full section of the composite abrasive 6 article through two inserts 7 and 8 on a surface being polished.

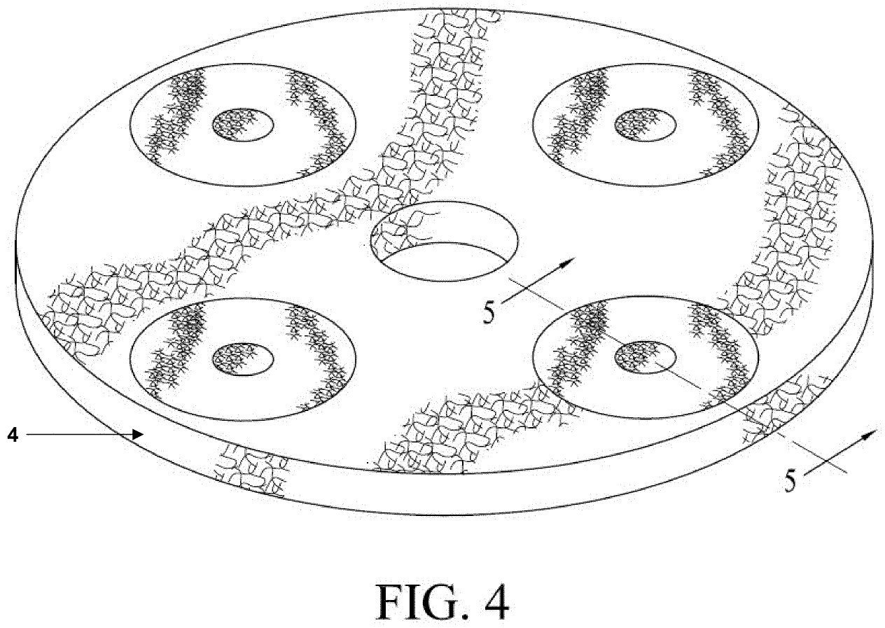

FIG. 4 illustrates a top perspective of the composite abrasive article 4 of the invention showing how the insert occupies the entire hollow cut through the nonwoven driver.

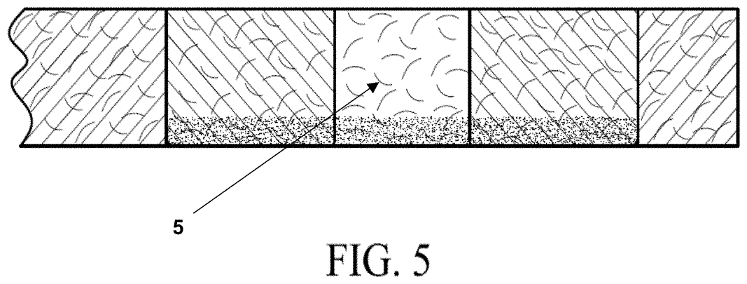

FIG. 5 shows a section through one of the inserts 5 of the invention.

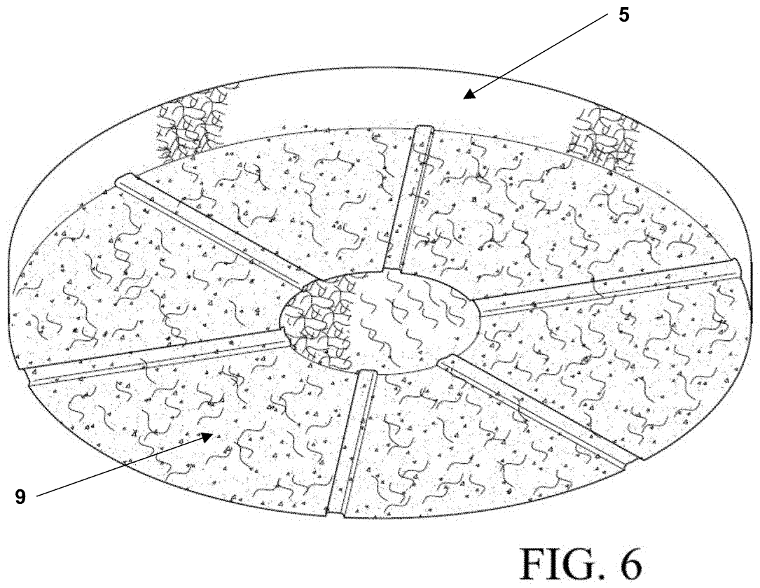

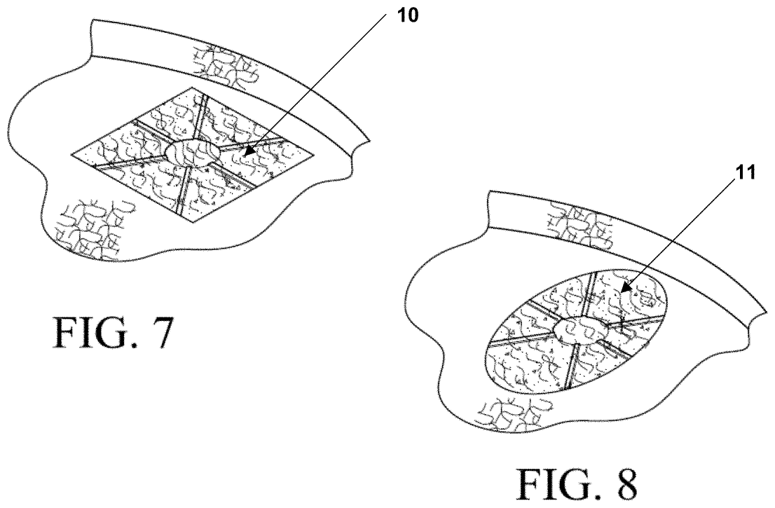

In FIG. 6 there is illustrated a whole insert 5 having a diamond polishing surface 9, while in FIG. 7 there is shown an insert element 10 having a square geometry. In FIG. 8 there is shown an insert element 11 in an oval/elliptical geometry.

The articles of the invention can be properly packaged and manufactured as kits for use in the commercial market.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

Having generally described this invention, a further understanding can be obtained by reference to certain specific examples, which are provided herein for purposes of illustration only, and are not intended to be limiting unless otherwise specified.

### Example I

### Procedure for Making Silicone Molds

A translucent cylindrical silicone rubber mold 4″ dia×⅝″ high was cast in a ring of Schedule 40 PVC plumbing pipe using Sylgard™ 184 elastomer (Dow Corning). A plastic core was used to form a flat-bottomed cylindrical cavity 3½″ in diameter and ¼″ deep. The core included six grooves which were triangular in cross-section 1/16″ wide× 1/16″ deep and arranged radially on the core face at 2:00, 4:00, 6:00, 8:00, 10:00 and 12:00 positions. The mold casting was allowed to cure for 4 hours at room temperature.

### Example II

### Procedure for Making Nonwoven Insert Substrates

Toroid-shaped insert substrates were cut from nonwoven pad material using a cylindrical rule die and a 20-ton hydraulic die press. The insert substrates were 3½″ outside dia., 1″ inside dia.

### Example III

### Procedure for Making Nonwoven Driver Articles

Four cylindrical cavities 3½″ dia. were cut completely through the thickness of a 20″ diameter nonwoven pad, using a using a 3½″ cylindrical rule die and a 20-ton hydraulic die press. The through-cavities were spaced at 3:00, 6:00, 9:00 and 12:00 positions near the periphery of the 20″ diameter nonwoven pad. The cavities were spaced approximately 8″ radially from the center of the nonwoven pad to the center of the cavities. The material cut from inside the cylindrical cavities was removed.

### Example IV

### Procedure for Measuring Compression Resistance of Nonwoven Materials

A procedure based on ASTM D6571-01 was used to measure the compression resistance of various nonwoven insert and driver materials. Cylindrical test samples were cut from nonwoven materials using a 4″ dia. rule die and a 20-ton hydraulic press. Individual samples were tested in an apparatus as described in ASTM D6571, using various weights for different samples. The compression resistance % as described in section 10.1.1 of ASTM D6571 was then normalized to yield a compression index equaling the percent compression per applied load mass.

### Example V

### Procedure for Making Nonwoven Insert Articles

The following components listed in Table 1 are used to make the nonwoven insert articles.

TABLE 1

| | Amount |
|---|---|
| Component | (grams) |
| (acrylate resin) trimethylol propane triacrylate | 133.32 |
| (silane coupling agent) gamma- | 3.75 |
| methacryloxypropyltrimethoxysilane | |
| (photo initiator) bis(2,4,6-trimethylbenzoyl)- | 3.00 |
| phenylphosphineoxide | |
| (amorphous silica) amorphous silica filler | 3.90 |
| (thermal initiator) 2,2′-azobis(2,4-dimethylvaleronitrile), | 0.03 |
| (mineral fiber) mineral fiber | 3.00 |
| (wollastonite powder) calcium silicate | 141.00 |
| (alumina powder) platey white alumina | 4.64 |
| (fired agglomerated particle) agglomerated abrasive | 7.36 |
| particles | |

Slurry components were mixed together in order as listed in Table 1. An IKA RW20 electric mixer and a 2″ four-blade impeller were used to mix components at 300 rpm for ˜15 minutes. A silicone mold produced by Procedure 1 was sprayed with Frekote Exitt silicone mold release (Henkel Corp.) and allowed to air-dry for ˜5 minutes at room temperature.

Thirty-two grams of abrasive slurry mix was poured into the mold cavity. The mold was agitated by hand to release air bubbles from the mold surfaces and from within the slurry liquid. A nonwoven insert substrate produced by Example II was placed in the mold cavity and downward pressure applied by hand to force the slurry into the lofty nonwoven face of the insert substrate.

A Sunray model 400SM UVA light source, obtained from Uvitron International Inc., was placed on a horizontal surface with the UV bulb and reflector facing upward. The UV lamp was turned on and allowed to warm up for 15 minutes with the power switch set to “standby”.

The silicone mold containing the insert substrate and abrasive slurry was placed directly onto the UV lamp shielding glass above the UV lamp bulb. The UV power source was switched on to “high.” After ˜15 seconds, the abrasive slurry which had impregnated into the insert substrate was at least partially cured to a rigid state, and the mold was removed from over the UV lamp.

The at least partially cured abrasive insert was removed from the silicone mold by peeling the elastomeric mold body from the insert. The de-molded, at least partially cured insert was placed back on the UV light source for ˜40 seconds to ensure complete curing of the abrasive insert.

### Example VA

Using the same procedure as in Example V and the components in Table 1A similar polishing inserts are made.

TABLE 1A

| | Amount |
|---|---|
| Component | (grams) |
| (acrylate resin) trimethylol propane triacrylate | 267 |
| (silane coupling agent) gamma- | 7.50 |
| methacryloxypropyltrimethoxysilane | |
| (photo initiator) bis(2,4,6-trimethylbenzoyl)- | 6.00 |
| phenylphosphineoxide | |
| (amorphous silica) amorphous silica filler | 7.80 |
| (thermal initiator) 2,2′-azobis(2,4-dimethylvaleronitrile), | 0.06 |
| (mineral fiber) mineral fiber | 6.00 |
| (wollastonite powder) calcium silicate | 282.00 |
| (alumina powder) platey white alumina | 9.28 |
| (fired agglomerated particle) agglomerated abrasive | 17.72 |
| particles | |

### Example VB

Using the same procedure as in Example V and the components in Table 1B similar polishing inserts are made.

TABLE 1B

| | Amount |
|---|---|
| Component | (grams) |
| (acrylate resin) pentaerythritol triacrylate | 278 |
| (silane coupling agent) gamma- | 7.50 |
| methacryloxypropyltrimethoxysilane | |
| (photo initiator) bis(2,4,6-trimethylbenzoyl)- | 6.00 |
| phenylphosphineoxide | |
| (amorphous silica) amorphous silica filler | 7.80 |
| (thermal initiator) 2,2′-azobis(2,4-dimethylvaleronitrile), | 0.06 |
| (mineral fiber) mineral fiber | 6.00 |
| (wollastonite powder) calcium silicate | 282.00 |
| (alumina powder) platey white alumina | 9.28 |
| (fired agglomerated particle) agglomerated abrasive | 17.72 |
| particles | |

### Example VI

### Method for Testing Floor Pads

Rectangular sections (approximately 3½ ft (1.07 m)×36 ft (10.97 m), 126 sqft (11.70 sqm)) of a concrete floor were initially prepared using a 20″ (50.8 cm) planetary grinder Model 500 with metal- and resin-bond diamond tooling available from HTC Floor Systems, Knoxville Tenn. The diamond sequence was: #40, #80, #120 grit metal-bond tools, followed by #100, #200, #400, #800, #1500, #3000 grit resin-bond tools. Silicate densifier (available from Ameripolish, Lowell AR, under the trade designation 3DHS) was applied to the floor after the #400-grit step, and the final #3000-grit polished surface was sealed with two applications of impregnating sealer (available from Ameripolish, Lowell AR, under the trade designation SR2). Densifier and sealer were applied according to the manufacturer's instruction procedures. The test floor areas were then

burnished with a 3M Diamond Purple Pad Plus (PP) using an electric burnisher model BR-2000, available from Tennant Company, Minneapolis Minn. Finally, a measurement grid with 18 separate test areas approximately 2′ (0.61 m)×2′ (0.61 m) was laid out on the prepared floor sections for subsequent recording of surface profile and aesthetic measurements.

A self-propelled autoscrubber model T3, available from Tennant Company, Minneapolis Minn., was used to simulate a floor cleaning protocol. Example and Comparative floor pads were mounted on the autoscrubber driver plate and repeatedly traversed across the previously prepared concrete test surfaces, with application of water and neutral cleaner continuously supplied by the autoscrubber. The autoscrubber downforce was kept on the “low” setting, which from the manufacturer's product specification was approximately 40 lb (18.1 kg).

Over the course of a test, 1000 passes were completed with the autoscrubber, maintaining a constant forward speed of approximately 80 ft/min (24.4 m/min). Measurements of floor roughness and aesthetic quality were made every 100 passes according to Example VII.

### Example VII

### Method for Measuring Floor Surface Properties

Surface roughness Rk was measured using a diamond stylus profilometer model Mahrsurf M300, available from Mahr Corporation, Cincinnati Ohio Aesthetic qualities DOI, haze, and gloss were measured using a model 408 goniophotometer, available from Elcometer Inc, Rochester Hills Mich.

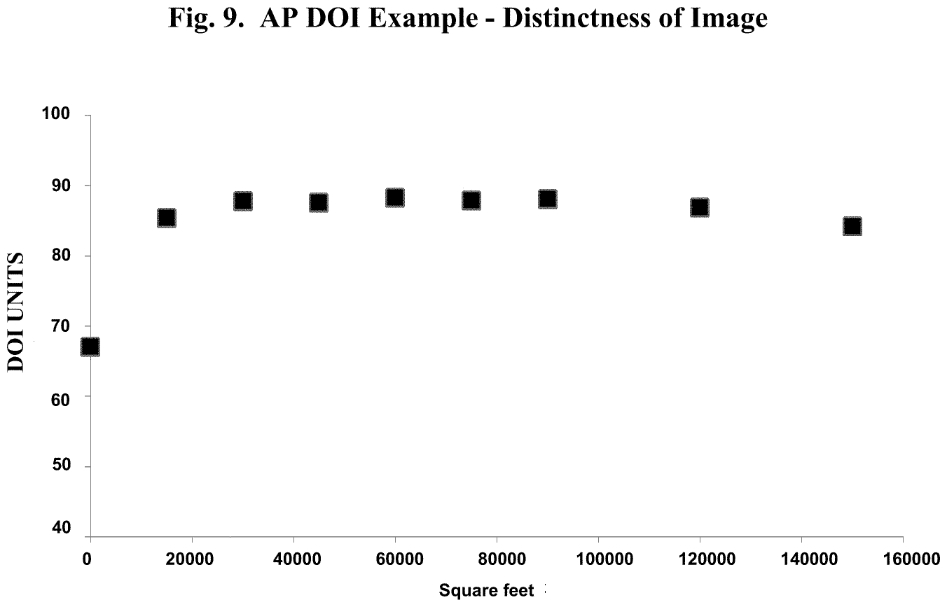

Six profilometer and six goniophotomer measurements were taken in each of 18 delineated test grid areas. Measurement data from each test interval were compiled and examined for normality, equality of variance, and single-factor ANOVA. Test data are summarized in Table 3 and FIGS. 9-17.

In the present specification the following definitions and methods when discussing the floor surface properties:

### Haze Units (HU)

Highly aesthetic surfaces have a clear, deep, brilliant reflective finish. Haze causes a drop in reflected contrast and causes halos to appear around light sources. These unwanted effects dramatically reduce visual aesthetic quality. A surface that has a perfect undisorted images returns a Haze value of 0. As the Haze value increases the reflected image contrast becomes less distinct. Haze units are expressed in accordance with ASTM D4039.

### Distinctness of Image (DOI)

Distinctness of Image measures the sharpness of a reflected image in a polished surface. Similar surfaces may have identical gloss or “shininess” values but visually the quality may be very different. A visually poor surface may have a highly textured dimpled appearance known as “orange peel”. When a reflected object is viewed in such a surface the image becomes fuzzy and distorted.

A surface that reflects a perfect undisorted image returns a DOI value of 100. As the DOI value decreases toward zero the image becomes more fuzzy and distorted. DOI units are expressed in accordance with ASTM D4039.

### Surface Roughness

Surface roughness, often shortened to roughness, is a component of surface texture. It is quantified by the deviations in the direction of the normal vector of a real surface from its ideal form. If these deviations are large, the surface is rough; if they are small, the surface is smooth.

Roughness plays an important role in determining how a real object will interact with its environment. Rough surfaces typically wear more quickly and have higher friction coefficients than smooth surfaces. Aesthetically, a smooth surface generally has, for example, higher distinctness of image (DOI) and lower haze than a rough surface. Roughness is often a good predictor of the performance of a mechanical component, since irregularities in the surface may form nucleation sites for cracks or corrosion. On a floor surface, abrasion from dirt and foot traffic, for example, can result in scratches and wear patterns on the surface which can be measured and quantified.

Roughness can be measured using a diamond stylus profilometer such as a Mahr M300, available from Mahr Corporation, Cincinnatti Ohio. Roughness parameter Ra is the measurement of the arithmetic average of scratch depth over an instrument sampling interval. It is the average of 5 individual roughness depths of five successive measurement lengths, where an individual roughness depth is the vertical distance between the highest point and a center line. Roughness parameter R_{z} is the average of 5 individual roughness depths of a measuring length, where an individual roughness depth is the vertical distance between the highest point and the lowest point. Roughness parameter Rk describes the “core” average roughness quality of a surface. It is derived from the Abbot-Firestone or bearing area curve, a cumulative probability density function of the surface profile's height. Compared to Ra and Rz, the Rk parameter reduces the skewing effects of extreme outliers on the average roughness values Rz and Rz reported. Surface roughness parameters Ra, Rz, and Rk are expressed as linear dimensions, typically microns (μm) or micro-inches (μin) in accordance with ASTM D7755.

### Example VIII

A composite abrasive article (as shown in FIG. 1, element 2) was assembled, combining Driver (FIG. 2, numeral 4) and Insert (FIG. 2, numeral 5) components. A Driver component was produced according to Example III and Insert components according to Example V. Insert substrate and driver materials were selected with consideration of relative compression resistances (Table 2) suitable for Driver and Insert functions.

TABLE 2

| | Compression Resistance (%) | |
|---|---|---|
| Sample | BP | WP |
| A | 73.6 | 83.9 |
| B | 89.2 | 91.7 |
| C | 90.8 | 94.1 |
| D | 87.9 | 92.0 |

In this Example, BPA material was selected for the Driver component, and WPA material for the Insert components, so that the Insert substrate compression resistance was approximately 14% greater than the compression resistance of the Driver component.

The assembled composite article was tested according to Example VI, and test results collected according to Example VII. The test results are summarized in Table 3.

### Comparative Example A

A 3M Purple Diamond Floor Pad Plus diamond-impregnated floor pad (PP) was tested according to Procedure 6, and test results recorded according to Example 7. The test results are summarized in Table 3.

### Comparative Example B

A HTC Twister Green diamond-impregnated floor pad (GP) was tested according to Procedure 6, and test results recorded according to Example 7. The test results are summarized in Table 3.

Measured values and percent change notations (4%) are listed in Table 3 for each example and test interval, showing the magnitude and trend of measured values over the course of a 1000-pass test. For example, the data for “Example VIII” in Table 3 show that after 100 passes from the start of the test, average DOI increased from 67.07 units to 85.43 units, a 27.4% increase (+27.4), and from 100 to 200 passes, DOI increased again, from 85.43 units to 87.82 units, a further 2.8% increase (+2.8). For the “Comp A” example, after the first 100 passes, average DOI decreased from 74.82 units to 59.45 units, a 20.5% decrease (−20.5). and from 100 to 200 passes, average DOI decreased again, from 59.45 units to 56.25 units, a further 5.4% decrease (−5.4%). The measured values and trends are presented graphically in FIGS. 9-17.

FIG. 9 is a graph of reflected image quality, DOI, using an Example VIII article. One can dearly see that DOI increases, improving image clarity, then maintains at an improved level.

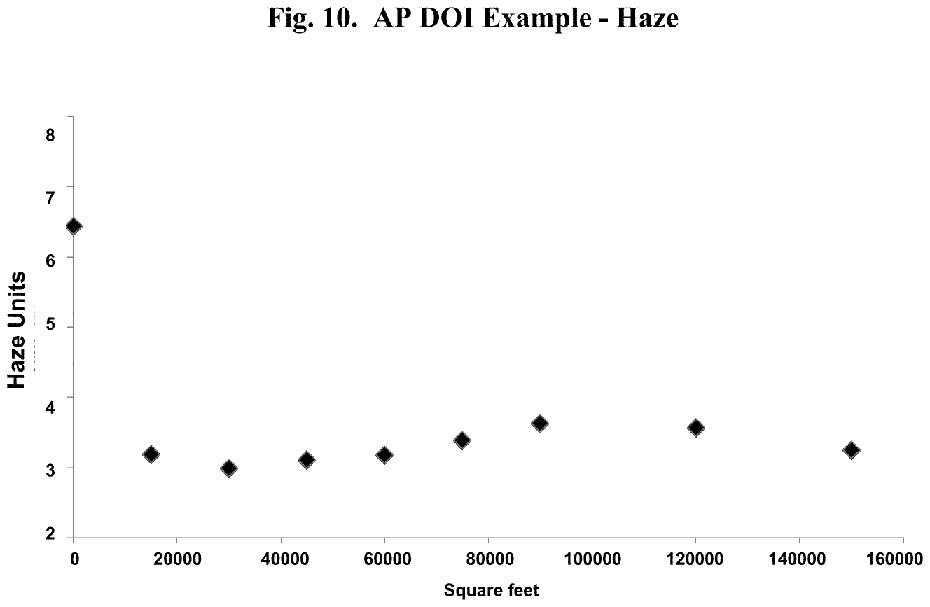

In FIG. 10 there is shown a graph of reflective image quality, Haze, using an Example VIII article where it s seen that haze decreases, improving image sharpness, then maintained at an improved level.

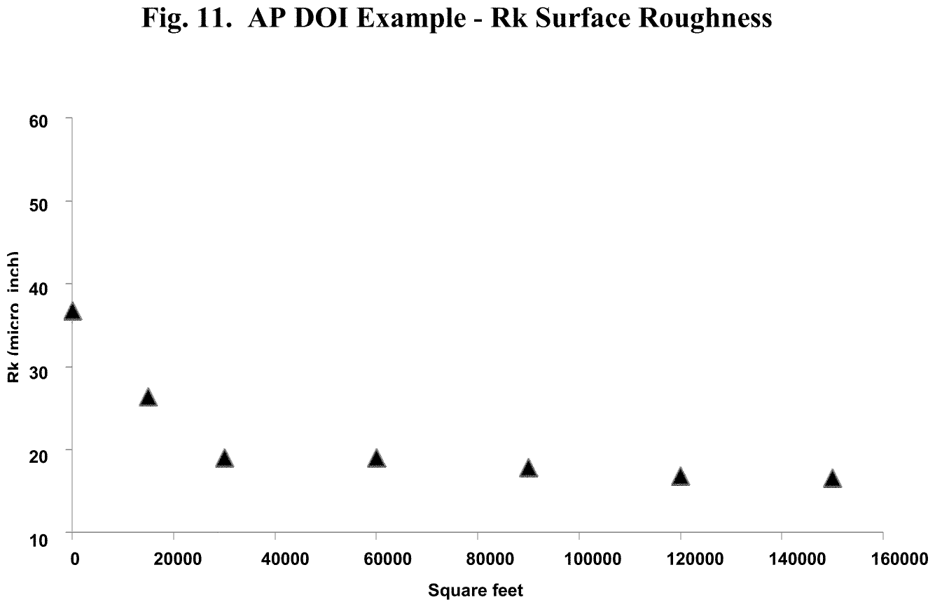

FIG. 11 illustrates a graph of surface roughness, Rk, using an Example VIII article which shows that surface roughness Rk decreases, then maintains at a decreased level.

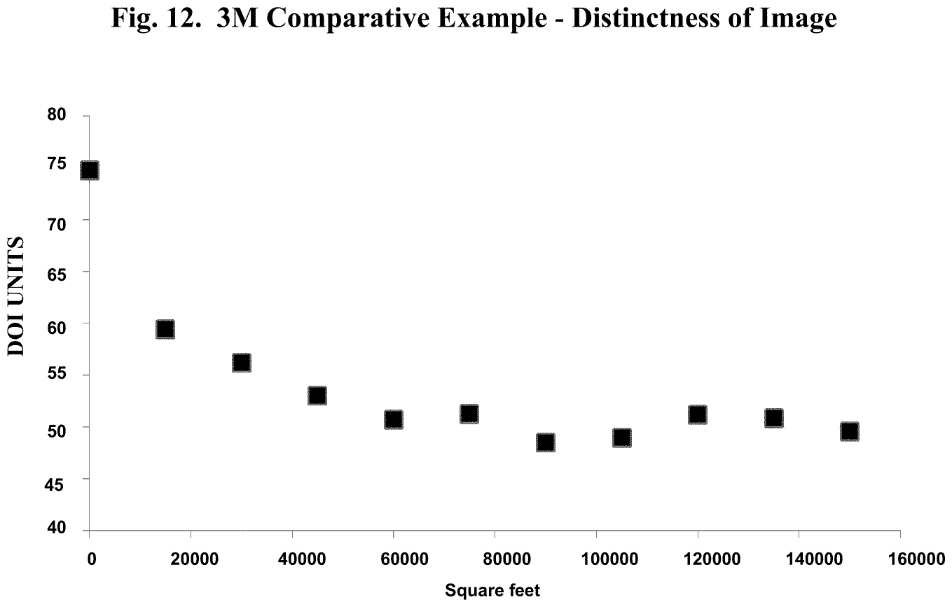

The FIG. 12 graph shows the reflected image quality, DOI using a Comparative Example A nonwoven abrasive article (3M). The data clearly shows that DOI decreases, degrading image clarity, then maintained at a degraded level.

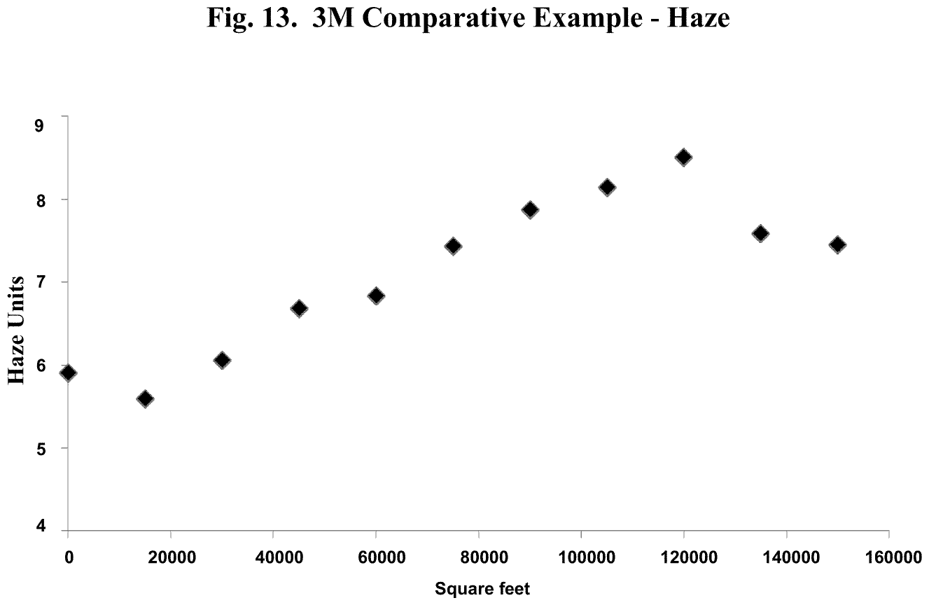

FIG. 13 shows a graph of reflected image quality, haze, using a Comparative Example A nonwoven abrasive article (3M). The graphical data shows that haze increases, continuously degrading image sharpness over time.

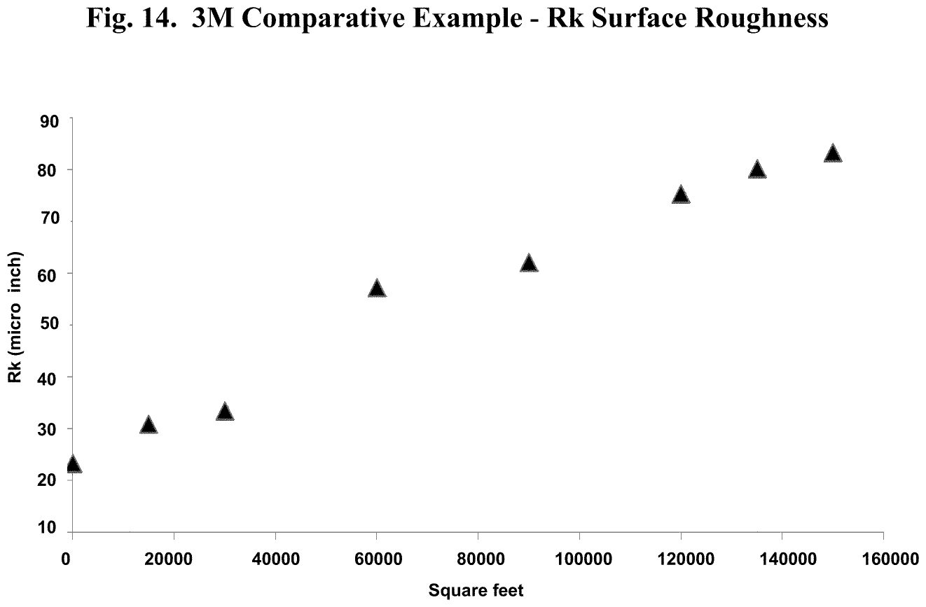

FIG. 14 illustrates the surface roughness, Rk, using a Comparative Example A nonwoven abrasive article (3M) which shows that Rk increases, continuously making the surface rougher over e.

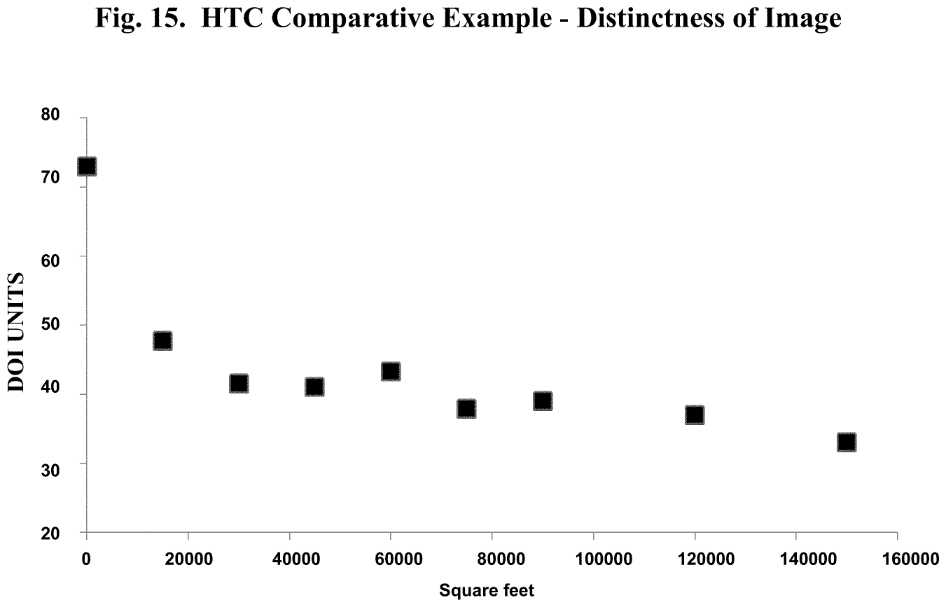

FIG. 15 shows reflected image quality, DOI, using a Comparative Example B nonwoven abrasive article (HTC) where it is noted that DOI decreases, continuously degrading image clarity over time.

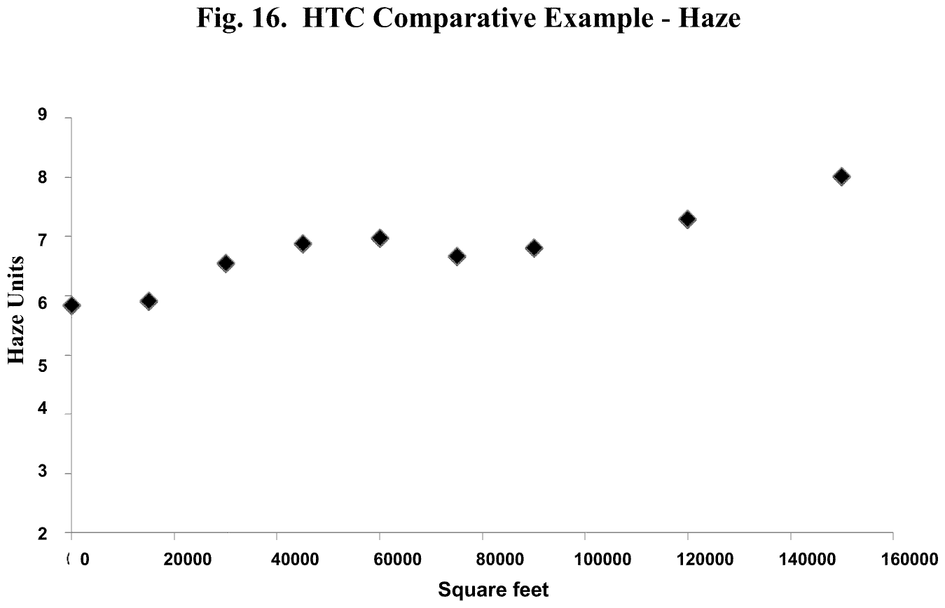

FIG. 16 is another graph of reflected image quality, haze, using a Comparative Example B nonwoven abrasive article (HTC) which clearly shows that haze increases, continuously degrading image sharpness over time.

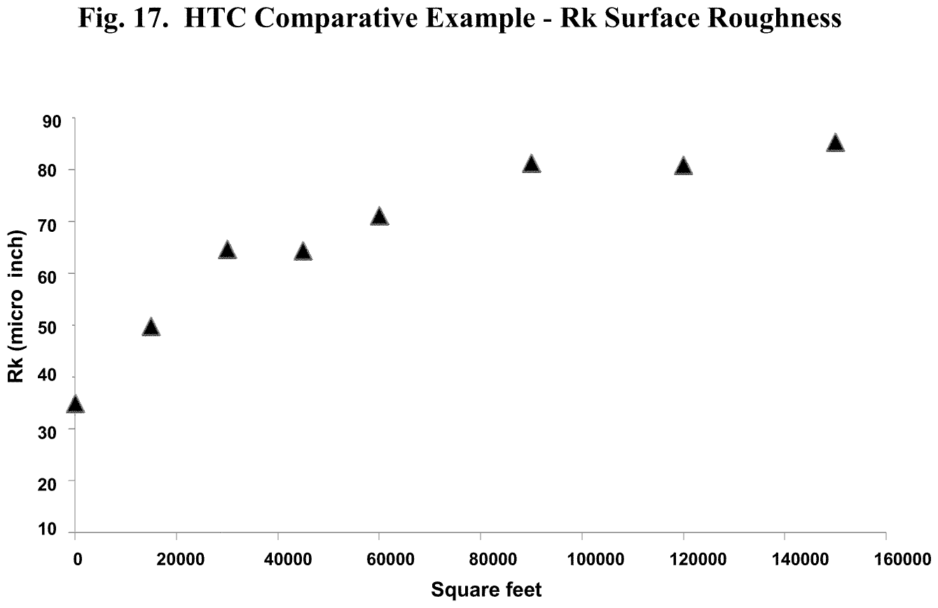

FIG. 17 illustrates the surface roughness, Rk, using a Comparative Example A nonwoven abrasive article (3M) where it is shown that Rk increases, continuously making the surface rougher over time.

### Example IX

A two-layer composite pad was laminated together using a Hot Coat Plus 12 hot-melt laminator and GIA1051 Permanent EVA hot-melt glue, both available from Glue Machinery Corporation. A rectangular, non-perforated base or bottom layer was die-cut to 8½″×12″. The base layer was a polyester felt material, 0.250″ thick, with a basis weight of 64 oz/sqyd, obtained from Superior Felt, item number 164250. The top layer was cut to the same rectangular size, and five 3⅜″ diameter holes were die-cut through the non woven pad thickness. The top layer pad material, obtained from Americo Manufacturing, Acworth GA, was a polyester nonwoven material with a thickness of 0.39″ and a basis weight of 17.5 oz/sqyd.

TABLE 3

| | | Distinctness of Image (DOI units) | | | Haze (Haze units) | | | Rk surface roughness (μin) | | |
|---|---|---|---|---|---|---|---|---|---|---|
| Machine | | Example | Comp A | Comp B | Example | Comp A | Comp B | Example | Comp A | Comp B |
| Passes | Sq. ft | VIII (Δ %) | (Δ %) | (Δ %) | VIII (Δ %) | (Δ %) | (Δ %) | VIII (Δ %) | (Δ %) | (Δ %) |
| Start | 0 | 67.07 | 74.82 | 72.99 | 6.45 | 5.91 | 5.85 | 36.81 | 23.39 | 34.99 |
| 100 | 15000 | 85.43 | 59.45 | 47.78 | 3.20 | 5.60 | 5.91 | 26.40 | 31.02 | 49.87 |
| | | (+27.4) | (−20.5) | (−34.5) | (−50.4) | (−5.2) | (+1.0) | (−28.3) | (+32.6) | (+42.5) |
| 200 | 30000 | 87.82 | 56.25 | 41.59 | 2.99 | 6.06 | 6.55 | 19.05 | 33.51 | 64.81 |
| | | (+2.8) | (−5.4) | (−13.0) | (−6.6) | (+8.2) | (+10.8) | (−27.8) | (+8.0) | (+30.0) |
| 300 | 45000 | 87.59 | 53.08 | 41.09 | 3.12 | 6.69 | 6.89 | | | 64.52 |
| | | (−0.3) | (−5.6) | (−1.2) | (+4.3) | (+2.2) | (+4.7) | | | (−0.4) |
| 400 | 60000 | 88.28 | 50.77 | 43.35 | 3.19 | 6.84 | 6.98 | 19.07 | 57.31 | 71.19 |
| | | (+0.8) | (−4.4) | (+5.5) | (+2.2) | (+2.2) | (+1.3) | (+0.10) | (+71.0) | (+10.3) |
| 500 | 75000 | 87.93 | 51.30 | 38.01 | 3.40 | 7.44 | 6.67 | | | |
| | | (−0.4) | (+1.0) | (−12.3) | (+6.6) | (+8.8) | (−4.4) | | | |
| 600 | 90000 | 88.12 | 48.52 | 39.09 | 3.64 | 7.87 | 6.82 | 17.86 | 62.25 | 81.41 |
| | | (+0.2) | (−5.4) | (+2.8) | (+7.0) | (+5.8) | (+2.2) | (−6.3) | (+8.6) | (+14.4) |
| 700 | 105000 | | 48.99 | | | 8.15 | | | | |
| | | | (+1.0) | | | (+3.6) | | | | |
| 800 | 120000 | 86.87 | 51.26 | 37.11 | 3.58 | 8.51 | 7.31 | 16.85 | 75.38 | 81.02 |
| | | (−1.4) | (+4.6) | (−5.1) | (−1.6) | (+4.4) | (+7.2) | (−5.6) | (+21.1) | (−0.5) |
| 900 | 135000 | | 50.94 | | | 7.59 | | | 80.25 | |
| | | | (−0.6) | | | (−10.8) | | | (+6.5) | |
| 1000 | 150000 | 84.20 | 49.63 | 33.07 | 3.26 | 7.46 | 8.02 | 16.62 | 83.36 | 85.42 |
| | | (−3.1) | (−2.5) | (−10.9) | (−8.9) | (−1.7) | (+9.7) | (−1.4) | (+3.9) | (+5.4) |

All patents, patent applications and publications cited in this application including all cited references in those patents, applications and publications, are hereby incorporated by reference in their entirety for all purposes to the same extent as if each individual patent, patent application or publication were so individually denoted.

While the many embodiments of the invention have been disclosed above and include presently preferred embodiments, many other embodiments and variations are possible within the scope of the present disclosure and in the appended claims that follow. Accordingly, the details of the preferred embodiments and examples provided are not to be construed as limiting. It is to be understood that the terms used herein are merely descriptive rather than limiting and that various changes, numerous equivalents may be made without departing from the spirit or scope of the claimed invention.

What is claimed is:

1. An article of manufacture useful for simultaneously maintaining, cleaning and polishing hard surfaces comprising independently a driver element composite pad comprised of a top non-woven layer and one or more non woven bottom layers laminated together with an adhesive interlayer, said composite pad having a central opening extending through all the layers and one or more equidistant or non-equidistant openings on the top nonwoven layer therein and polishing inserts elements disposed in said equidistant or non-equidistant openings, wherein said article upon repeatedly cleaning and polishing a previously-prepared surface provides a decreased surface roughness value, an increased distinctness of image value, and a decreased haze value.

2. A method of cleaning and polishing a previously-prepared surface with the article of manufacture of claim 1, wherein upon repeatedly cleaning and polishing, provides when compared to the previously prepared surface, a reduced surface roughness value, an increased distinctness of image value, and a decreased haze value.

3. The method of claim 2, wherein the surface roughness value is decreased by at least 5 percent.

4. The method of claim 2, wherein the distinctness of image value is increased by at least 5 percent.

5. The method of claim 2, wherein the haze value is decreased by at least 5 percent.

6. The article of claim 1 wherein said driver element is a cleaning element.

7. The article of claim 6, wherein said cleaning element is a non-woven web.

8. The article of claim 7, wherein said non-woven web is a polyester non-woven web.

9. The article of claim 7, wherein said non-woven web is a polyamide non-woven web.

10. The article of claim 8, wherein said polyester is a polyalkylene terephthalate.

11. The article of claim 10, wherein said polyalkylene terephthalate is polyethylene terephthalate.

12. The article of claim 9, wherein said polyamide is Nylon 6 or Nylon 66.

13. The article of claim 1, wherein said polishing insert element comprises a non-woven web having on one of its surfaces abrading particles.

14. The article of claim 13, wherein said abrading particles are agglomerate abrasive particles.

15. The article of claim 1, wherein said polishing insert elements occupy space through the entire thickness of the entire driver element.

16. The article of claim 1, wherein said driver element and said polishing insert element have the same compression resistance values.

17. The article of claim 1, wherein said driver element and said polishing insert element have different compression resistance values.

18. A polishing element comprising a non-woven web having a top surface and a bottom surface; said polishing element having incorporated all across one of its surfaces abrasive particles and wherein said polishing element upon repeatedly cleaning and polishing a previously-prepared surface provides a decreased surface roughness value, an increased distinctness of image value, and a decreased haze value.

19. The polishing element of claim 18, wherein said non-woven web is a polyester non-woven web.

20. The polishing element of claim 18, wherein said abrading particles are agglomerate abrasive particles.

21. A kit for cleaning and polishing hard surfaces comprising:
(a) a driver element comprising a composite pad comprised of a top non-woven layer and one or more non woven bottom layers laminated together with an adhesive interlayer having a central opening extending through all the layers and one or more equidistant or non-equidistant openings on the top layer; and
(b) polishing inserts elements for said driver element having equidistant or non-equidistant openings; and wherein said kit provides upon repeatedly cleaning and polishing a previously-prepared surface provides a decreased surface roughness value, an increased distinctness of image value, and a decreased haze value.

22. The kit of claim 21, wherein said driver element composite pad layers is polyester non-woven web.

23. The kit of claim 21, wherein said polishing insert elements include agglomerate abrasive particles.
